(19) United States
(12) Patent Application Publication
(10) Pub. No.: US 2024/0257659 A1
(43) Pub. Date: Aug. 1, 2024

(54) COCKPIT WITH VIRTUAL CONTROL ELEMENTS

(71) Applicant: Deutsches Zentrum für Luft- und Raumfahrt e.V., Bonn (DE)

(72) Inventor: Ina Rüdinger, Heideck (DE)

(21) Appl. No.: 18/425,696

(22) Filed: Jan. 29, 2024

(30) Foreign Application Priority Data
Feb. 1, 2023 (DE) 10 2023 102 428.0

(51) Int. Cl. G09B 9/24

(52) U.S. Cl. CPC G09B 9/24

(57) ABSTRACT

A system for cockpit operation by an operator, including a computing unit, a virtualization unit, and two exoskeleton arms with position measurement, wherein the computing unit actuates the virtualization unit to display virtual control elements of the cockpit control elements in such a way that a current position of a virtual control stick correlates with a position of a first exoskeleton arm and a current position of a virtual thrust lever correlates with a position of the second exoskeleton arm, and transfers information about current positions of the virtual control elements or positions of the exoskeleton arms as command signals to a flight computer.

### CROSS-REFERENCE TO RELATED APPLICATIONS

This application claims benefit of German Patent Application No. 10 2023 102 428.0, filed on 1 Feb. 2023, the contents of which are incorporated herein by reference in their entirety.

### BACKGROUND

### Field

The invention relates to a system for cockpit operation and to an aircraft having such a system.

### Related Art

Cockpits for aircraft, drone ground stations and simulators represent the human-machine interface between the operator and the machine. In manned flight control, operating elements for controlling subsystems of the aircraft are typically available to an operator. Such operating elements relate to communication, navigation, lights, and, depending on the aircraft type, and more. For flight control itself, i.e., to influence an aircraft state with components for torque dynamics (roll movement, pitch movement, yaw movement) and components for translational accelerations and speeds, appropriate operating elements are available depending on the configuration of the aircraft. While such control elements in fixed-wing aircraft typically include a control stick for controlling pitch and roll movements, as well as one or more thrust levers for setting a desired thrust lever position correlating with a desired thrust of the aircraft engine(s), as well as pedals for controlling a torque about the vertical axis of the aircraft, rotary-wing aircraft typically have a collective lever instead of, or in addition to, the thrust lever in order to be able to change the collective blade adjustment angle of adjustable rotor blades at the same or approximately the same rotor speed-this corresponds to the basic control logic of a conventional helicopter.

Special configurations of manned aircraft often have peculiarities in terms of their degrees of freedom in thrust and aerodynamic control surfaces, which can be reflected in the designs of the control elements in the cockpit of the manned aircraft. Thus, helicopters with tandem rotors may have two collective control levers, and different designs of the operating elements are described in the prior art for different configurations and the associated purposes of the aircraft. Common designs are control horns, center sticks or sidesticks.

However, the operating elements mentioned at the beginning are also available in a wide variety depending on the configuration and type of manned aircraft. While only analogue instruments (displays) and mechanical switches and buttons were installed in historical aircraft, modern aircraft increasingly use digital displays, which can at least partially take over the function of control elements by being designed as touchscreens.

While manufacturers attach great value to commonality in cockpit design, particularly in commercial aviation, in order to reduce costs and increase the operational readiness of pilots across aircraft of different types in a fleet, pilots are generally still faced with a variety of different cockpit layouts, when changing aircraft types. While it is currently known that, as in most other industries, there is increasing digitalization in aviation (in aviation, especially with regard to analogue instruments), the control elements for controlling the aircraft are still typically implemented physically, as explained at the beginning.

The typical problem for left-handed people of being faced with control elements that were basically designed for right-handed people is also present in aviation. These problems arise not only in manned aircraft, but also in unmanned aircraft, where ground control stations are designed in such a way that, for example, the system operator has one hand available for operating the payload (e.g., a camera) and the other for writing. For cost reasons regarding the hardware design, drone ground control stations are often designed identically, regardless of handedness, but also in terms of the task (drone control, system operator).

### SUMMARY

It is therefore the aim of the invention to make a cockpit more flexible, in particular, to provide a cockpit which is suitable for a larger number of different body sizes of operators and experiences of operators, in particular, against the backdrop of taking into account the gender-neutral anthropometrics, which, in particular, in the narrow fighter cockpit poses a particular challenge.

The invention results from the features of the independent claims. Advantageous further developments and embodiments are the subject matter of the dependent claims.

A first aspect of the invention relates to a system for cockpit operation by an operator, in particular, for the cockpit of a real or simulated aircraft, including a computing unit, a virtualization unit, and two exoskeleton arms, each with a large number of kinematic degrees of freedom and for accommodating the operator arms, wherein the computing unit is designed to determine desired positions of virtual control elements of the cockpit depending on the current position of the exoskeleton arms and to actuate the virtualization unit to display to the operator the virtual control elements in their desired positions, as well as to transmit information about the current positions of the exoskeleton arms and/or the desired positions of the virtual control elements to a flight computer for the purpose of flight control or control of a simulation.

The first aspect of the invention is to be understood, in particular, in such a way that the computing unit is basically designed to virtually set the positions of the virtual control elements depending on the respectively determined position of the respective exoskeleton arms and thus to emulate the operation of physically present control elements in the traditional cockpit in order to be able in both cases (physically present control elements and use of the exoskeleton arms according to the invention for operating virtual control elements) to provide corresponding commands for, in particular, a flight computer. However, this does not mean that the virtual control elements must also be adjusted at all times and therefore with every movement of the operator's arms and the exoskeleton arms moved along. Moreover, the operator is preferably able to release at least one hand from one of the virtual control elements and thus also to operate virtual operating elements in the cockpit, for example, the landing gear lever, buttons and switches for navigation, icons on a virtual touchscreen, etc.

The positions of the virtual control elements of the cockpit correspond to corresponding flight control commands depending on the type of control elements. If the control element is a thrust lever, its position is a thrust lever position. If the control element is a control stick, its position is a deflection from a neutral position and typically specifies the desired attitude angle of the aircraft, but more often the desired rotation rates of the aircraft.

The term cockpit includes not only the cabin part typically located in the area of an aircraft front for the operator such as the pilot, copilot, or another operator in the cockpit such as the so-called “backseater”, e.g., the weapon system officer, but also cockpits for remotely controlled aircraft of a drone ground station, provided for a drone pilot and/or a system operator-such a system operator can operate payloads such as cameras via a joystick, for example. The term cockpit also refers to the cockpit of a (flight) simulator.

Provided that not only a HOTAS concept (HOTAS is the acronym for Hands on Throttle and Stick) is provided, but also virtual operating elements similar to a traditional physically present cockpit with a variety of switches and buttons are displayed in the virtualization for the operator in addition to the virtual control elements, it is therefore appropriate to provide a mechanism that does not convert the current position of the respective exoskeleton arm at all times when there is a request to adjust the current position of one specific element of the virtual control elements, but also takes into account the virtual analogue to release a hand from a physical control element. This can be implemented, for example, by providing a physically present handle at a respective distal end of an exoskeleton arm, which detects sensorily whether the operator's hand is currently gripping it. In this way, the intuitive gripping of a control element by the operator can be replicated. If the operator lets go of this physical element, it can also be assumed in the virtual cockpit that the operator wants to release their hand from the control element, for example, to rest it or to use a virtual operating element, which can also be displayed to the operator purely virtually using the virtualization.

In other words, according to the first aspect of the invention, physical control elements of a cockpit are replaced by the combination of the computing unit, the virtualization unit and the exoskeleton arms, which interact as follows: By moving their arms, which are accommodated in the exoskeleton arms, the operator can operate control elements, which are displayed to him/her exclusively virtually by the virtualization unit. This is done, for example, via a helmet visor with appropriate display capability or other holographic methods or the like. The operator's arms are accommodated in the exoskeleton arms, and preferably via position sensors in the exoskeleton arms, it is possible for the computing unit to determine the movement of the operator's arms at any time. This means that the operator can operate the virtually displayed control elements using usual movements, as if physical control elements were present in the cockpit. The same applies to operating elements, which can also be displayed virtually.

As a result, at the interface of generating the commands that are output by physical control elements, the type of specification of the operator commands is thus changed in its technical implementation; however, for the purposes of flight control in a flight computer, it does not matter whether the commands are generated in a new way before this interface. In both cases (physical control elements and virtual control elements), command signals are generated, which in a so-called fly-by-wire system are already transmitted only through information technology without mechanical connections to the aerodynamic control surfaces and to the engine control elements of an aircraft, but not through force, hydraulic pressure, cable pull or the like. Rather, the operator typically uses his/her inputs on the control elements (regardless of whether physical control elements or virtual control elements according to the invention are used) to command specification signals for, in particular, the flight computer, which implements the commands accordingly in terms of control technology. What has been said applies mutatis mutandis to simulations or drone ground stations.

It is an advantageous effect of the invention that the need to provide physical control elements such as control sticks and thrust levers is eliminated. This leads to some secondary advantages, for example, that weight is saved and changes to the cockpit can be easily carried out, since the virtual control elements and, if necessary, virtual operating elements only have to be changed via software in order to achieve a changed representation by the virtualization unit.

Accordingly, a familiar cockpit environment can also be represented in a foreign aircraft with a high level of flexibility for an operator, and individual characteristics of the operator can also be better taken into account, for example, size differences in anthropometric parameters (e.g., length of the limbs, size of the hands, sitting height of the person), left-handed or right-handed, and the like. By providing the virtual cockpit, a level of communalization can thus be achieved in civil fleets as well as in military fleets across different types of aircraft, which is hardly achievable in physical cockpits of different types of aircraft. Furthermore, the use of the exoskeleton arms enables the arms to be supported, so that fatigue of the operator's arms can be avoided for longer, even in highly agile aircraft with high load multiples. The exoskeleton with the two exoskeleton arms enables the feeling of being able to support the arm on the virtual control element while controlling the aircraft or even putting it down when such support is provided. If actuators are also provided on the exoskeleton arms, perceptible feedback can be generated for the operator. In addition, the flexibility of a software-based virtual solution enables easier standardization of cockpits and thus easier conversion between different aircraft types.

According to an advantageous embodiment, the exoskeleton arms have respective position sensors for their degrees of freedom for determining and transmitting to the computing unit a respective current value for each of the kinematic degrees of freedom, the computing unit being designed to use the values for the degrees of freedom to determine a position of a respective predefined reference point in the area of the respective distal end of the exoskeleton arms in relation to the cockpit, and to actuate the virtualization unit for displaying virtual control elements of the cockpit including a control element for manually controlling the torque dynamics of the aircraft and a control element for manually setting a thrust lever position for the operator so that a current position of the control element for manually setting the thrust lever position correlates with the position of the predefined reference point of an exoskeleton arm and a current position of the control element for manually controlling the torque dynamics correlates with the position of the predefined reference point on the other exoskeleton arm, and wherein the computing unit is designed to transmit to flight computer for the purpose of flight control the respective currently desired position of the virtual control elements or the respective position of the reference points.

Accordingly, a system for cockpit operation of an aircraft by an operator is provided, including a computing unit, a virtualization unit, and two exoskeleton arms, each with a large number of kinematic degrees of freedom and with respective position sensors for determining and transmitting to the computing unit a respective current value for each of the kinematic degrees of freedom, the computing unit being designed to use the values for each of the degrees of freedom to determine a position of a predefined reference point in the area of the respective distal end of the exoskeleton arms in relation to the cockpit, and to actuate the virtualization unit for displaying virtual control elements of the cockpit including a control element for manually controlling the torque dynamics of the aircraft and a control element for manually setting a thrust lever position for the operator so that a current position of the control element for manually adjusting the thrust lever position correlates with the position of the predefined reference point of an exoskeleton arm and a current position of the control element for manually controlling the torque dynamics correlates with the position of the predefined reference point on the other exoskeleton arm, and to transmit to a flight computer information on the respective current position of the virtual control elements or the positions of the reference points as command signals for the purpose of flight control.

As an alternative to calculating the respective current desired position of the virtual control elements using the position of the respective reference point on the exoskeleton arms, other geometric images can be used, which, however, have the same end result as the use of an explicitly specified reference point. It is therefore not necessary to specify the reference point explicitly; it can also be specified implicitly and can be calculated at all times, so that a transformation from the current pose of the exoskeleton arms to a current desired position of the respective associated virtual control elements is always possible, if appropriate conditions are met that indicate that the operator also wants to operate the respective control element instead of taking their hands off the virtual control elements, for example, to operate a virtual operating element.

In other words, the computing unit is designed to determine a respective position of the exoskeleton arms using the values for the degrees of freedom of the respective exoskeleton arms, and to determine a desired respective position of the virtual control elements depending on the respective determined position of the exoskeleton arms, and to transfer this determined desired position of the virtual control elements to the virtualization unit for its display to the operator of the virtual control elements at the desired position, as well as to transmit information about the respective current position of the virtual control elements or about the positions of the reference points as command signals to a flight computer for the purpose of flight control.

As an alternative to the position sensors in the exoskeleton arm, the exoskeleton arms can also be tracked by a tracking unit in the cockpit, for example, by optical tracking, corresponding reflective markers on the respective exoskeleton arm and corresponding cameras, or the like, in order to determine a pose of the respective exoskeleton arm, or alternatively just the reference point at the respective distal end of the respective exoskeleton arm, without taking the posture of the elbow into account.

According to an advantageous embodiment, the computing unit is designed to monitor the positions of the reference points relative to the cockpit to see whether they move away from at least one predefined area around the virtually displayed control elements, so that the operator can move their hand and move the respective virtual exoskeleton arm along to operate virtually represented operating elements to actuate subsystems of the aircraft and that of the virtually represented control elements in question remains in its current position when the operator moves their arm, which is accommodated in one of the exoskeleton arms, to an operating element of the cockpit, which is virtually represented by the virtualization unit, with predefined spatial coordinates relative to the cockpit .

According to a further advantageous embodiment, the system further has two gloves for the operator, the two gloves each being designed to output haptic and/or tactile feedback, the two gloves being connected to the computing unit in terms of data technology and the computing unit being designed so that when the operator operates one of the virtually displayed operating elements, that glove is controlled with the operator's virtually operating hand to output haptic and/or tactile feedback. Alternatively, the respective exoskeleton arm can be expanded to include the function of the gloves, so that it is a single unit.

The haptic or tactile feedback enables the operator to get the feeling of touching a physically present operating element, even though it only exists virtually and is represented to him or her. This can be used to recreate the feeling of flipping a switch, the feeling of pressing a button, or pressing a field on a touchscreen. A more abstract feedback can also be generated, for example, when operating elements represented as holographic elements are moved, so that the operator does not have the impression that he/she is operating virtual analogues of physical operating elements , but rather actual holographic elements, with corresponding feedback on the fingers in this case as well making operation easier for the operator.

According to a further advantageous embodiment, each of the exoskeleton arms has actuators which are connected to the computing unit in terms of data technology, the computing unit being designed to actuate the actuators in such a way that each of the exoskeleton arms when the operator moves the respective position of a respective one of the virtually represented control elements generates artificial resistance.

This artificial resistance is modeled on the natural resistance of a physical control element, which must be present in every aircraft in order not to cause corresponding control inputs due to vibrations and other accelerations of the aircraft itself. By replicating the resistance expected for physical control elements using artificial resistance, the operator gets a familiar feeling when operating the virtual control elements.

According to a further advantageous embodiment, the system further has an input unit which is connected to the computing unit in terms of data technology, the computing unit being designed to correspondingly virtually position the control elements in their virtual representation relative to the cockpit depending on the input at the input unit and to specify kinematic properties according to which the actuators of the exoskeleton arms are actuated by the computing unit to generate the artificial resistance.

The input unit makes it possible to set the position of the storage of the virtual control elements in the virtual cockpit before the flight (or in an alternative embodiment also during the flight of the aircraft). This position of the virtual control elements is decisive for whether an operator has an ergonomic cockpit, i.e., the relative distance between the operator's seat and the position of the control elements is adapted to the length of his/her limbs.

According to a further advantageous embodiment, the input unit is designed to specify an explicit selection for left-handed arrangement and right-handed arrangement of the control elements and the computing unit is designed so that, depending on the input at the input unit and on the current representation of the virtual control elements in accordance with user choice, it mirrors or maintains the positions of the virtual control elements relative to the cockpit with respect to a longitudinal axis of the aircraft.

According to a further advantageous embodiment, the computing unit is designed to actuate the actuators of the respective exoskeleton arm in such a way that the operator experiences resistance along predefined degrees of freedom of a respective virtual control element, which is changeable during flight within predefined limits depending on the aircraft condition or in response to an input from the operator.

According to a further advantageous embodiment, the virtualization unit includes a helmet display for the operator.

Another aspect of the invention relates to an aircraft with a system as described above and below.

According to a further advantageous embodiment, the exoskeleton arms are each mounted on the aircraft structure at shoulder height behind an operator seat.

Advantages and preferred refinements of the proposed aircraft result from an analogous and corresponding transfer of the statements made above in conjunction with the proposed system.

Further advantages, features, and details will be apparent from the following description, in which—possibly with reference to the drawings—at least one example embodiment is described in detail. Identical, similar and/or functionally identical parts are provided with the same reference numerals.

### BRIEF DESCRIPTION OF THE DRAWINGS

In the drawings:

FIG. 1 shows a system for cockpit operation of an aircraft in accordance with an example embodiment of the invention; and

FIG. 2 shows an aircraft with a system according to FIG. 1 in accordance with an example embodiment of the invention.

The illustrations in the figures are schematic and not to scale.

### DETAILED DESCRIPTION

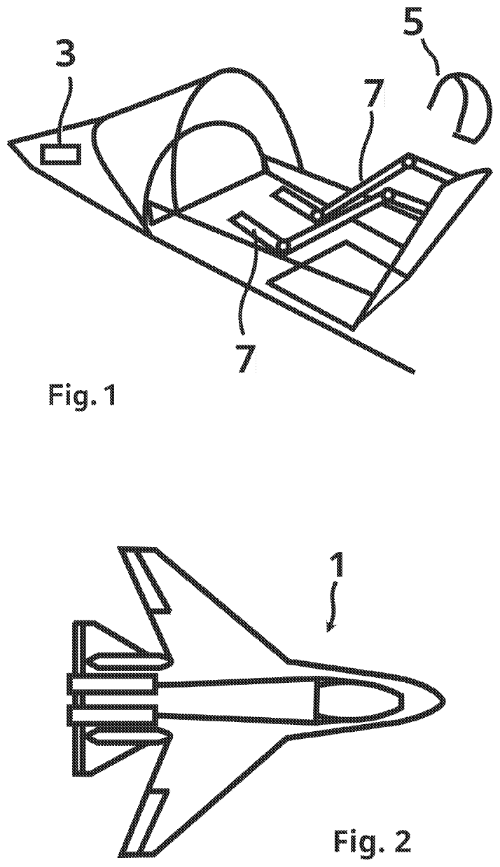

FIG. 1 shows a system for cockpit operation of a single-seat fighter aircraft 1 as an aircraft by an operator in the role of a pilot. Represented is a cockpit of the aircraft 1 of FIG. 2, with the main flight direction to the top left in the drawing plane of FIG. 1. The pilot's seat is represented further down to the right in the drawing. The system for cockpit operation includes the following: A computing unit 3, a virtualization unit 5, and two exoskeleton arms 7, each with a large number of kinematic degrees of freedom and with respective position sensors for determining and transmitting to the computing unit 3 a respective current value for each of the kinematic degrees of freedom. The position sensors are angle sensors that record the joint angles between the segments of the respective exoskeleton arm 7. These joint angles are set manually by the pilot's natural movement with their arms, and actuators can be provided to support the pilot in this desired movement against accelerations that occur, such as in tight turning flights at high speeds. A respective pose of the respective exoskeleton arm 7 is therefore known to the computing unit 3 at any time. The respective exoskeleton arm 7 is mounted on the aircraft structure at shoulder height behind the pilot and has shoulder joints and elbow joints to represent degrees of freedom, which are designed analogously to the degrees of freedom of the human shoulder and the human elbow, so that for the pilot's arm accommodated in the exoskeleton arm 7 all movements possible due to its degrees of freedom in the shoulder and elbow are also possible through the exoskeleton arm 7. The computing unit 3 uses these values for the degrees of freedom to determine the pose and thus a reference point on the respective exoskeleton arm 7 in relation to the cockpit in order to determine the desired positions of a virtual control stick and a virtual thrust lever. The virtualization unit 5 shows these virtual control elements of the cockpit (virtual control stick and virtual thrust lever) to the pilot via his/her helmet visor and updates the determined desired position of the virtual control stick and the virtual thrust lever in each subsequent time step. In addition, the computing unit 3 transmits these desired positions of the virtual control stick and the virtual thrust lever as command signals to a flight computer for the purpose of flight control. While the pilot's arms are continuously accommodated in each of the exoskeleton arms 7, the pilot does not want to continuously change a position of the virtual thrust lever or the virtual control stick with every movement. This is recognized by the computing unit 3 through a corresponding hand position by arranging handle sensors at the respective end of the exoskeleton arm 7, which detect whether or not a corresponding release movement of the pilot's respective hand occurs analogously to a release movement of physical control sticks and thrust levers. If the pilot releases at least one hand from one of these virtual control elements, it is assumed that he/she does not currently want to operate this control element and wants to change its position, but rather, for example, wants to operate one of the operating elements that are also represented virtually, such as a holographic touchscreen or virtual switches and buttons. Even when operating the virtual operating elements, the respective exoskeleton arm 7 remains enclosed on the respective pilot arm. Furthermore, two gloves are provided for the pilot, the two gloves each being designed to output haptic and/or tactile feedback, the two gloves being connected to the computing unit 3 for data technology and, when the pilot operates one of the virtually represented operating elements, the computing unit 3 actuates that glove with the pilot's virtually operating hand to output haptic and/or tactile feedback. The naturally expected resistance to a change in the respective position of the virtual operating elements is generated by actuators on the respective exoskeleton arm 7 in the area of the joints, analogously to a robotic manipulator.

FIG. 2 shows the aircraft 1 with the system according to FIG. 1 from a top view.

Although the invention has been further illustrated and described in detail by way of preferred example embodiments, the invention is not limited by the disclosed examples, and other variations can be derived therefrom by a person skilled in the art without departing from the scope of protection of the invention. It is therefore clear that a multitude of possible variations exists. It is also clear that exemplified embodiments are really only examples, which are not to be construed in any way as limiting the scope of protection, applicability, or configuration of the invention. Rather, the foregoing description and the description of the figures enable a person skilled in the art to implement the example embodiments, and such person may make various changes knowing the disclosed inventive concept, for example, with regard to the function or arrangement of individual elements cited in an example embodiment, without departing from the scope of protection as defined by the claims and their legal equivalents, such as more extensive explanations in the description.

### LIST OF REFERENCE NUMERALS

1 Aircraft
3 Computing unit
5 Virtualization unit
7 Exoskeleton arms

1. A system for cockpit operation by an operator, the system comprising:
two exoskeleton arms with each of the exoskeleton arms comprising a large number of kinematic degrees of freedom, wherein the exoskeleton arms are configured to accommodate respective operator arms;
a virtualization unit configured to display to the operator virtual control elements of the cockpit; and
a computing unit configured to determine desired positions of the virtual control elements of the cockpit depending on current positions of the respective exoskeleton arms, and further configured to actuate the virtualization unit to display to the operator the virtual control elements in their desired positions, as well as to transmit information about the current positions of the respective exoskeleton arms and/or the desired positions of the virtual control elements to a flight computer for a purpose of flight control or control of a simulation.

2. The system according to claim 1, wherein the exoskeleton arms include respective position sensors configured to determine and transmit to the computing unit a respective current value for each of their kinematic degrees of freedom, the computing unit being further configured to:
use values of the degrees of freedom to determine a first position of a first predefined reference point in an area of a distal end of a first exoskeleton arm in relation to the cockpit and further to determine a second position of a second predefined reference point in an area of a distal end of a second exoskeleton arm in relation to the cockpit;
actuate the virtualization unit to display the virtual control elements of the cockpit comprising a first control element to manually control torque dynamics of a real or a simulated aircraft associated with the cockpit and a second control element to manually set a thrust lever position for the operator, such that a current position of the first control element correlates with the first position of the first predefined reference point of the first exoskeleton arm, and such that a current position of the second control element correlates with the second position of the second predefined reference point of the second exoskeleton arm; and
transmit to the flight computer respective current positions of the virtual control elements or respective positions of reference points for the purpose of flight control or control of the simulation.

3. The system according to claim 2, wherein the computing unit is further configured to monitor the respective positions of the reference points relative to the cockpit to determine whether the reference points move away from at least one predefined area around virtually displayed control elements, such that the operator is capable of moving the operator's hand and a respective virtual exoskeleton arm so as to operate virtually represented operating elements in order to actuate subsystems of the aircraft and that the virtually represented control elements remain in their current position when the operator moves the operator's arm, which is accommodated in one of the exoskeleton arms, toward an operating element of the cockpit, which is virtually represented by the virtualization unit, with predefined spatial coordinates relative to the cockpit.

4. The system according to claim 3, wherein the system further comprises two gloves for the operator, each of the two gloves being configured to output haptic and/or tactile feedback, the two gloves connected to the computing unit in terms of data technology, wherein the computing unit is further configured such that when the operator operates one of the virtually represented operating elements, a glove is actuated with the operator's virtually operating hand to output the haptic and/or tactile feedback.

5. The system according to claim 3, wherein each of the exoskeleton arms includes actuators connected to the computing unit in terms of data technology, wherein the computing unit is further configured to actuate the actuators in such a way that each of the exoskeleton arms when the operator moves a respective position of a respective one of the virtually represented control elements creates artificial resistance.

6. The system according to claim 5, wherein the system further comprises an input unit connected to the computing unit in terms of data technology, wherein the computing unit is further configured to virtually position the control elements correspondingly as a whole in their virtual representation relative to the cockpit depending on input at the input unit and to specify kinematic properties according to which the actuators of the exoskeleton arms are actuated by the computing unit to generate the artificial resistance.

7. The system according to claim 6, wherein the input unit is further configured to specify an explicit selection for a left-handed arrangement and a right-handed arrangement of the control elements, wherein the computing unit is further configured so that, depending on the input at the input unit and on a current representation of a virtual control element, the computing unit mirrors or maintains positions of the virtual control elements relative to the cockpit with respect to a longitudinal axis of the aircraft.

8. The system according to claim 5, wherein the computing unit is further configured to actuate the actuators of a respective exoskeleton arm in such a way that the operator experiences resistance along predefined degrees of freedom of a respective virtual control element, the resistance changeable during flight within predefined limits depending on aircraft condition or in response to an input from the operator.

9. An aircraft comprising a system for cockpit operation by an operator according to claim 1.

10. The aircraft according to claim 9, wherein the exoskeleton arms are each mounted on a structure of the aircraft at shoulder height behind a seat of the operator.
